(19) United States
(12) Patent Application Publication
(10) Pub. No.: US 2022/0370171 A1
(43) Pub. Date: Nov. 24, 2022

(54) ORTHODONTIC APPLIANCE WITH ALIGNER AND ATTACHMENT

(71) Applicant: 1092228 B.C. LTD., Anmore (CA)

(72) Inventor: Zhi Chun Song, Anmore (CA)

(21) Appl. No.: 17/323,886

(22) Filed: May 18, 2021

(51) Int. Cl. A61C 7/08

(52) U.S. Cl. CPC A61C 7/08

(57) ABSTRACT

An orthodontic appliance for repositioning a tooth of a dental patient includes: (a) an attachment dimensioned for being attached to the tooth; and (b) an aligner having a cutout therein defining a cutout edge, the cutout edge defining a projection dimensioned to resiliently engage the attachment during installation of the aligner such that the projection inhibits dislocation of the aligner after the aligner has been installed.

The installed aligner may impart a force on the tooth via the attachment by contacting at least a portion of the cutout edge. A slot between a beveled base and overhang of the attachment guides the projection during aligner installation. Opposing projections form a passage therethrough. The attachment body in cross-section may be diamond-shaped. More than one attachment may be employed for a given cutout. The aligner may have a secondary cutout or window dimensioned to not engage with any attachment.

### BACKGROUND OF THE INVENTION

### 1. Field of Invention

This invention relates to orthodontic appliances and, in particular, to an orthodontic appliance involving the combined use of a dental aligner and a dental attachment.

### 2. Description of Related Art

Dental aligners are used to straighten teeth as an alternative to dental braces. Aligners are typically formed as removable plastic trays that are customized to a patient's dental arch. The aligner provides a geometry selected to reposition the teeth from one tooth arrangement to the next arrangement. There are discrepancies between the aligner and the teeth, and the force generated by these discrepancies reposition the teeth to the next arrangement. However, a counterforce to the aligner may also lead to minor displacement of the aligner from its fully installed position in the dental arch.

A dental attachment is an object that is attached directly to the surface of a tooth of the patient. Dental attachments were introduced into dental treatment to improve the treatment result. The term “aligner system” refers to the combined use of one aligner and one or more dental attachments on the same dental arch of the patient. After more than 15 years of clinical use and improvement of aligner systems, there are still many problems in the treatment of difficult orthodontic cases.

Tooth tipping and minor dislocation of aligners often happen. The conventional aligner system, which consists of the aligner and the attachments, cannot prevent gradual unintentional dislocation of the aligner. Incomplete insertion may also result in aligner dislocation.

United States Patent application publication No. 2019/0274788 to Cetta et al. discloses orthodontic elastic attachments that are customized to fit with the cutout of the aligner with a gingival side opening. The base pad has a shape that complements the shape of the plastic window such that it fits within the aligner's cut-out like a puzzle piece. So the base pad has contact with the cutout edge, but the aligner system of Cetta et al. does not have features to prevent the aligner from dislocation.

United States Patent application publication No. 2004/0048223 to Phan et al. discloses an aligner system wherein the aligner slides over the attachments to fit into the designated place; and the aligner slides over the attachments again when the aligner is removed from the dental arch. This sliding over mechanism cannot prevent minor dislocation if the dislocation force is very big, and the retention force generated by the engagement between the attachment and the aligner is not big enough to hold the aligner in place. This aligner system of Phan et al. cannot prevent gradual displacement from the fully installed position.

Some improvement needs to be made to solve these problems.

### SUMMARY OF THE INVENTION

To prevent minor displacement of the aligner from its fully installed position on the dental arch and other problems with conventional aligner systems, the present invention provides an orthodontic appliance comprising: (a) an attachment dimensioned for being attached to the tooth; and (b) an aligner having a thickness and having a cutout which has an opening toward gingival therein defining a cutout edge, the cutout edge defining a projection, wherein the projection and the attachment are dimensioned to resiliently engage with each other to counteract the dislocation force generated by the interaction between the aligner and the teeth and to maintain the aligner in a fully installed position.

A cutout of the aligner may be located on the buccal and/or lingual surface of the teeth when the aligner is installed, and the cutout may have an opening dimensioned for being oriented towards the gingival. A projection of the aligner from the mesial side and/or the distal side of the cutout toward the interior of the cutout is provided.

One or more attachments may be dimensioned for being attached to the tooth surface whereat the cutout is aligned, the attachment having a body and a base, the base being connected to the tooth surface, and the body projecting away from the tooth, wherein the height of the body is longer than the thickness of the aligner at the cutout edge, and the attachment body side surface is dimensioned to inhibit the projection from sliding over the top surface of the attachment when the aligner is being displaced from its fully installed position.

The attachment body may have a protrusion which projects in the opposite direction of the projection of the aligner, the tip of the projection of the aligner being at the gingival side of the tip of the protrusion of the attachment body when the aligner is in the fully installed position and the projection of the aligner contacts the attachment body.

The projection of the aligner may be squeezed by the protrusion of the attachment body during insertion and removal of the aligner. The tip of the projection of the aligner may contact the tip of the protrusion of the attachment body during installation of the aligner. The projection of the aligner may reach its biggest deformation when contacting the attachment body protrusion, and the attachment body may deliver the biggest compressive force to the aligner at the tip of the attachment body protrusion. After the projection of the aligner passes the tip of the attachment body protrusion, the attachment body may give the projection of the aligner a compressive force which at least has a component force directed toward the gingiva, this force may guide the aligner to fit into the fully installed position automatically. This function can prevent incomplete insertion. To make automatic insertion at the final stage of the insertion happen, the projection of the aligner may have a smoothly rounded edge and the attachment body protrusion may have a smooth and gradual changing side surface so the friction force between the attachment body and the projection of the aligner, which may hinder auto-insertion, can be minimized. When the aligner is fully installed, the attachment body may still give the projection of the aligner a compressive force which at least has a component force toward the gingival, this component force being a retention force, which may counteract the dislocation force received by the aligner, to prevent minor dislocation, and the magnitude of the retention force may balance the dislocation force by regulation of the thickness of the aligner and/or the prominence of the projection of the aligner and/or the prominence of the protrusion of the attachment body.

The side wall of the attachment dimensioned to prevent the projection of the aligner from sliding over the top surface of the attachment body during insertion, thereby preventing a lack of a compressive force big enough to counteract a dislocation force received by the aligner when it is in the fully installed position.

At least part of the side surface of the attachment body may form an acute angle or right angle with the tooth surface, and the attachment body may be long enough that the projection of the aligner can not slide over the top surface of the attachment body so the projection of the aligner can only slide along the side surface of the attachment body.

The attachment may include a wing of the attachment separated from the base, a slot being formed between the wing and the base (or the tooth surface when the base does not extend laterally beyond the attachment body), and the slot having an opening whose width is bigger than the thickness of the aligner at the cutout edge, such that the projection of the aligner slides in the slot when the aligner is being inserted or removed.

The cutout may have an opening at the gingival side, and this opening may permit the attachment, which is much higher than the thickness of the aligner, to enter the cutout area during insertion or removal.

The attachment body may contact the cutout edge, and this contact may hold the appliance in the designated place of the dental arch and/or reposition the tooth to the next arrangement. The cross section of the attachment body may have any suitable shape including a circle, oval, triangle, polygon, etc. The engagement modes between the attachment and the cutout edge may have a few styles but are not limited to these styles. In the first style the attachment body has contact with all of the cutout edge; in the second style the attachment body contacts only the lingual portion of the cutout edge; in the third style the attachment body contacts only the occlusal portion of the cutout edge; in the fourth style the attachment body contacts the lingual portion and the mesial portion or the distal portion of the cutout edge; in the fifth style the attachment body contacts the lingual portion, the mesial portion and the distal portion of the cutout edge; in the sixth style the attachment body contacts the occlusal portion and the mesial portion and/or the distal portion of the cutout edge.

The attachment is preferably positioned in the inner part of the cutout when the aligner is in its designated position. In some embodiments, only part of the attachment is in the inner part of the cutout when the aligner is in its designated position on the dental arch, such that the other part of the attachment may be out of the cutout.

The teeth generally refer to all natural and non-natural teeth in a patient's dentition. In the present invention, the attachment device is bonded to and/or formed over a dental feature in a desired location. The attachment device may be bonded to any of these teeth with any suitable bonding material, typically dental restorative composites.

In the present invention, the attachment devices may be constructed from a variety of materials, including but not limited to metals, glass, porcelain or silicone filled polymers, and other composite materials. Such materials are typically designed to be chip, break and shear resistant for durability. The base of the attachment device may be constructed from the same or from different materials as the attachment body. Likewise, the attachment body may be permanently or removably mounted on the base or the body and base may be constructed as one entity.

In the present invention the attachment may also include or function as a hook for traction in some situations. This attachment can be used in the intramaxillary traction or intermaxillary traction.

In the present invention the aligner may extend to cover some gingiva around the teeth when the aligner is inserted on the dental arch. Sometimes the crown height of the teeth is not enough, such that the aligner extends towards the gingiva around the teeth.

In the present invention two attachments can be designed for being located within one cutout of the aligner.

In the present invention one or more cutouts or windows may be provided in the aligner to increase the elasticity of the aligner in some location(s). A window or cutout may be close to the projection of the aligner to increase the elasticity in that part of the aligner. The cutout(s) may make the insertion and removal of the aligner easier by decreasing the retention force. The window(s) may make the insertion and removal of the aligner easier by decreasing the retention force.

In the present invention at least part of the side surface of the attachment body forms an angle smaller than 120 degrees with the base (or the tooth surface when the base does not extend laterally beyond the attachment body).

In the present invention at least part of the side surface of the attachment body forms an angle smaller than 140 degree with the base (or the tooth surface when the base does not extend laterally beyond the attachment body).

In the present invention the side surface of the attachment body has a smooth and gradually changed surface which is less prominent as it is farther away from the tip of the attachment body protrusion.

In the present invention the attachment base may be contoured for an intimate fit with the local tooth surface. The base may have beveled edges, so the aligner can slide over the base easily. The base may be covered by the aligner when the aligner is in its designated position.

In the present invention, the projection tip of the aligner may be smoothly rounded.

In the present invention, the outer perimeter of the base may coincide with that of the attachment body which will be bonded to the surface of the tooth. Alternatively, the base may be an enlarged portion of the body, so as to increase the surface area of the bond. The enlarged base pad may be partially covered by the aligner when the aligner is in its designated position.

In the present invention the height of the attachment body may be at least 1.4 times the thickness of the aligner at the cutout edge.

In the present invention the height of the attachment body may be at least 1.8 times the thickness of the aligner at the cutout edge.

In the present invention the opening of the cutout may be very narrow. The tip of the projection may be dimensioned to contact a portion of the aligner at the opposite side of the cutout opening. The attachment body may be operable to separate contact between the tip of the projection and the portion during insertion and removal of the aligner. The portion may be an opposing projection tip.

In accordance with another aspect of the invention, there is provided an orthodontic appliance for repositioning a tooth of a dental patient. The appliance includes: (a) first means for imparting a force to a tooth of the patient, the first means being attached to the tooth; and (b) second means for aligning at least one tooth of the patient, the second means being removably installable on a dental arch of the patient, the second means including third means for resiliently engaging the first means so as to hinder the displacement of the second means from its fully installed position.

The orthodontic appliance may further include fourth means for increasing a flexibility of the second means.

The foregoing summary is illustrative only and is not intended to be in any way limiting. Other aspects and features of the present invention will become apparent to those of ordinary skill in the art upon review of the following description of embodiments of the invention in conjunction with the accompanying figures and claims.

### BRIEF DESCRIPTION OF THE DRAWINGS

In drawings which illustrate by way of example only embodiments of the invention:

FIG. 1 is a perspective view of the orthodontic appliance according to a first embodiment of the invention, showing an aligner having a cutout and an attachment attached to a tooth of a patient;

FIG. 2 is a close-up perspective view of a portion of the orthodontic appliance shown in FIG. 1;

FIG. 3 is a close-up perspective view of the portion shown in FIG. 2, showing initial contact between the aligner and attachment;

FIG. 4 is a close-up perspective view of the portion shown in FIGS. 2 and 3, showing the aligner fully installed and engaging the attachment;

FIG. 5 is a top view of the attachment of FIG. 4 and the cutout of the aligner when it is fully installed, showing contact between the attachment and a projection of the aligner;

FIG. 6 is a top view of the attachment and the cutout of the aligner shown in FIG. 5, showing the attachment in a second, different position;

FIG. 7 is a top view of the attachment and the cutout of the aligner shown in FIGS. 5 and 6, showing the attachment in a third position;

FIG. 8 is a top view of the cutout of the aligner shown in FIGS. 5 to 7, showing an alternative attachment having a different position and size;

FIG. 9 is a top view of the cutout of the aligner shown in FIGS. 5 to 8, showing a third attachment having an ellipical shape;

FIG. 10 is a top view of the cutout of the aligner shown in FIGS. 5 to 9, showing a fourth attachment having a triangular shape and showing, by dotted line, the aligner displaced from its fully installed position;

FIG. 11 is a top view of the cutout of the aligner shown in FIGS. 5 to 10, showing the cutout and attachment having complementary shapes;

FIG. 12 is a side sectional view of the portion of the appliance shown in FIGS. 4 and 5, showing an attachment body of the attachment contacting a first portion of the aligner projection and not showing other portions of the aligner;

FIG. 13 is a side sectional view of the portion shown in FIG. 12, showing a variation of the attachment having a short attachment body;

FIG. 14 is a side sectional view of the portion shown in FIGS. 12 and 13, showing a varied attachment body whose side surface forms an acute angle with a tooth surface;

FIG. 15 is a side sectional view of the portion shown in FIGS. 12 to 14, showing a varied attachment body whose side surface forms an obtuse angle with the tooth surface;

FIG. 16 is a side sectional view of the portion shown in FIGS. 12 to 15, showing the attachment having a base that extends laterally beyond the attachment body;

FIG. 17 is a side sectional view of the portion shown in FIG. 16, showing the attachment having a beveled base;

FIG. 18 is a side sectional view of the portion shown in FIGS. 16 and 17, showing the attachment and its base having smoothly rounded edges;

FIG. 19 is a perspective view of a variation of the attachment shown in FIGS. 1 to 18, showing the attachment having a wing;

FIG. 20 is a perspective view of a further variation of the attachment shown in FIG. 19, showing an elliptical wing;

FIG. 21 is a side sectional view of the portion shown in FIGS. 12 to 18, showing the variation of the attachment having a wing;

FIG. 22 is a side sectional view of the portion shown in FIG. 21, showing a variation of the attachment having the wing and the beveled base;

FIG. 23 is a side sectional view of the portion shown in FIGS. 21 and 22, showing a variation of the attachment having a single-sided wing;

FIG. 24 is a side sectional view of the portion shown in FIG. 23, showing a variation of the attachment having a slot of inwardly decreasing width;

FIG. 25 is a close-up perspective view of a portion of the appliance according to a second embodiment of the invention, showing a cutout having a pair of opposing projections and the attachment having a circular base and a circular wing;

FIG. 26 is a perspective view of the portion shown in FIG. 25, showing initial contact between the aligner and the attachment;

FIG. 27 is a perspective view of the portion shown in FIGS. 25 and 26, showing the aligner fully installed and engaging the attachment;

FIG. 28 is a top view of the cutout of the aligner and the attachment of FIG. 27, shown for clarity without the base and the wing, showing the aligner in its fully installed position;

FIG. 29 is a top view of the cutout of the aligner shown in FIG. 28, showing a variation of the attachment body having a parallelogram-shaped cross-section;

FIG. 30 is a top view of the cutout of the aligner shown in FIGS. 28 and 29, showing a further variation of the attachment body having a bullet-shaped cross-section;

FIG. 31 is a top view of a variation of the portion of the appliance shown in FIGS. 28 to 30, showing a diamond-shaped cutout;

FIG. 32 is a top view of a portion of the appliance according to a third embodiment of the invention, showing a secondary cutout and a window dimensioned to not engage with any attachment;

FIG. 33 is a top view of a variation of the portion shown in FIG. 32, showing one secondary cutout;

FIG. 34 is a close-up perspective view of a portion of the appliance shown in FIG. 33, showing the attachment having a circular base and a circular wing;

FIG. 35 is a top view of a portion of the appliance according to a fourth embodiment of the invention, showing a pair of attachments dimensioned for engaging a pair of opposing projections of the aligner, respectively;

FIG. 36 is a top view of a portion of the appliance according to a fifth embodiment of the invention, showing a pair of opposing projections in contact with each other at their respective projection tips; and

FIG. 37 is a top view of a portion of the appliance according to a sixth embodiment of the invention, showing the projection tip contacting the aligner at the opposite side of the opening.

### DETAILED DESCRIPTION

An orthodontic appliance for repositioning a tooth of a dental patient includes: (a) first means for imparting a force to a tooth of the patient, the first means being attached to the tooth; and (b) second means for aligning at least one tooth of the patient, the second means being removably installable on a dental arch of the patient, the second means comprising third means for resiliently engaging the first means so as to counteract a dislocation force generated by the interaction between the second means and the teeth of the patient after the second means has been fully installed on the dental arch. The orthodontic appliance may further include fourth means for increasing a flexibility of the second means.

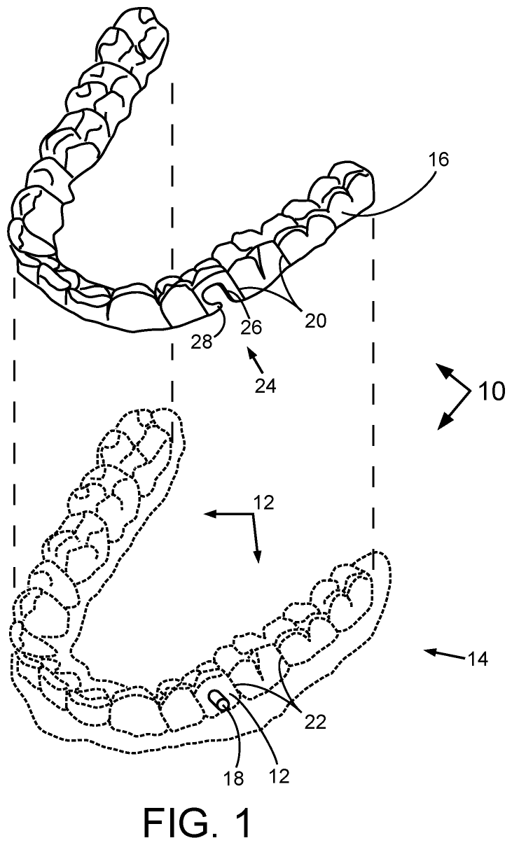

Referring to FIG. 1, the orthodontic appliance is an apparatus according to a first embodiment of the invention that is shown generally at 10. The appliance 10 functions to reposition one or more teeth 12 of a dental arch 14 of a dental patient. In FIG. 1, the dental arch 14 and its teeth 12 are shown by dotted line. The appliance 10 involves the combination of an aligner 16 and an attachment 18 dimensioned for being attached, such as by adhesive bonding, to a given tooth 12.

While FIG. 1 shows one attachment 18 attached to one tooth 12, in general any number of attachments 18 attached to any number of teeth 12 of an upper and/or lower dental arch 14 may be employed to achieve a desired dental result.

Referring to FIGS. 1 to 4, the aligner 16 is typically made of a resilient material custom-fitted to the shapes of the teeth 12 of the dental arch 14. The aligner 16 typically includes inward facing ridges 20 associated with the natural indentations 22 between adjacent pairs of teeth 12. A given ridge 20 must typically be selected to conform to its associated indentation 22 for a natural fit of the aligner 16 to the dental arch 14 resulting in the insertion route 32 of the aligner being determined. The insertion and removal of the aligner 16 must typically follow the same route 32.

Formed within the aligner 16 is a cutout 24 that defines a cutout edge 26. In the embodiments of FIGS. 1 to 4, the cutout 24 is open toward the gingiva of the patient to permit removable installation of the aligner 16 onto the dental arch 14 of the patient.

The aligner 16 along its cutout edge 26 defines a projection 28 that projects inwardly into the cutout 24. The projection 28 must typically follow the insertion route 32 during insertion or removal of the aligner 16. The projection 28 is dimensioned to resiliently engage the attachment 18 during installation of the aligner 16 (FIGS. 3 and 4) such that the projection 28 hinders minor dislocation of the aligner 16 after the aligner 16 has been installed. In the exemplary embodiments of FIGS. 1 to 4, the projection 28 has a smoothly rounded tip 30 for ease of installation of the aligner 16.

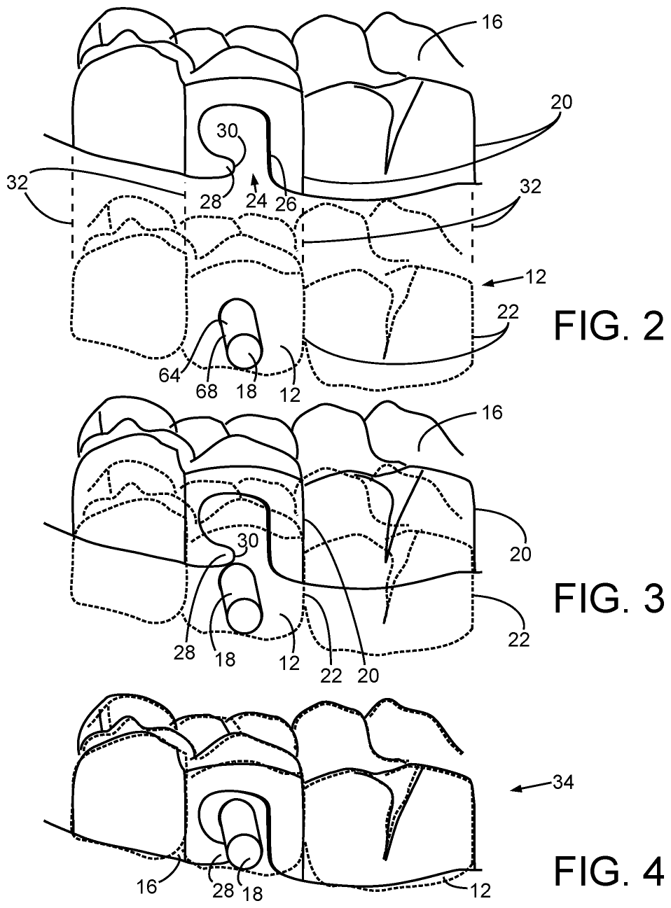

Referring to FIGS. 2, 3 and 4, the projection 28 must collide with the attachment 18 when it follows the insertion route 32 to insert the aligner 16 into the fully installed position 34. The projection 28 is squeezed by the attachment 18 during the aligner insertion. The attachment 18 directs a compressive force on the projection 28 during installation of the aligner 16. From a point of initial contact (FIG. 3), such compressive force increases as the aligner 16 is moved toward its fully installed position 34 (FIG. 4). Midway between initial contact and the fully installed position 34, a point of maximum compressive force is reached. Thereafter, the compressive force becomes reduced or released as the aligner 16 is moved into its fully installed position 34. Thus, the resilient engagement of the projection 28 against the attachment 18 advantageously prevents incomplete installation of the aligner 16 by urging the aligner 16 toward its fully installed position 34 after having reached its midway point of maximum compressive force.

As indicated in FIGS. 3 and 4, the aligner 16 is typically transparent or clear such that the teeth 12 are visible beneath the aligner 16. In variations, the projection 28 can project inwardly toward the interior of the cutout 24 from anywhere along the cutout edge 26, and in general any number of projections 28 may be employed. Usually a cutout 24 is located on the buccal and/or the lingual surface of the teeth when the aligner is installed, and the cutout 24 has an opening dimensioned for being oriented towards the gingival. The projection 28 of the aligner 16 projects from the mesial side and/or the distal side of the cutout 24 toward the interior of the cutout 24.

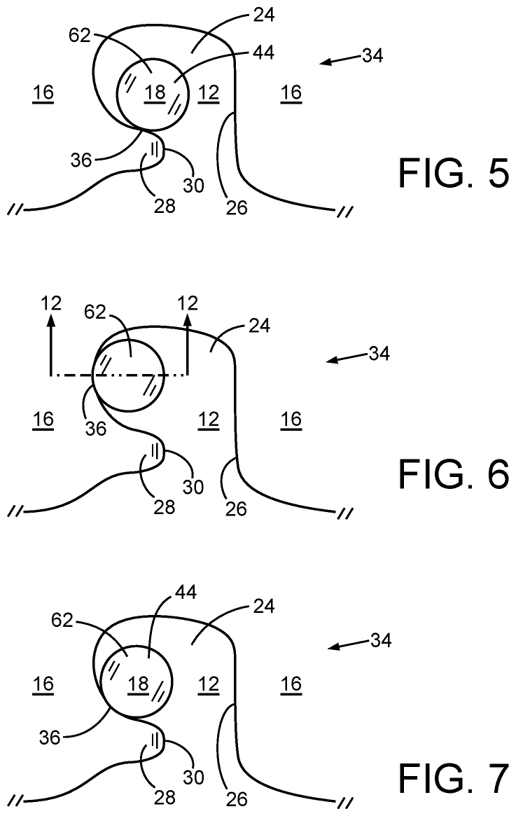

Referring to FIG. 5 in top view, the aligner 16 of some embodiments in its fully installed position 34 places the projection 28 in contact with the attachment 18.

Referring to FIGS. 2 to 5, in the embodiment a situation analogous to insertion happens during dislocation of the aligner 16 because the removal also follows the same route 32. The projection 28 contacts the attachment 18 at the contact point 36 when the aligner is in its fully installed position 34, such that the attachment 18 may deliver a retention force to the aligner 16 through the projection 28. In most cases the dental arch 14 may also deliver a dislocation force to the aligner 16. If there is a dislocation force on the aligner 16, the protrusion 16 and the attachment 18 are dimensioned and positioned to resiliently engage with each other to counteract the dislocation force to maintain the aligner 16 in the fully installed position 34.

Referring to FIGS. 5 to 7, the attachment 18 may in general contact the cutout edge 26 at any contact point 36 thereof when the aligner 16 (a portion only of which is seen in FIGS. 5 to 7) is in its fully installed position 34. Such fully installed position 34 of the aligner 16 provides in some embodiments a persistent force by the aligner 16 at the contact point 36 to the given tooth 12 via the attachment 18. Such persistent force persists for the duration of time that the aligner 16 remains in its installed position, and typically acts to reposition the given tooth 12 in a desired direction. The attachment 18 need only contact a portion of the cutout edge 26 when the aligner 16 is in its fully installed position 34 for such persistent force to act as a repositioning force.

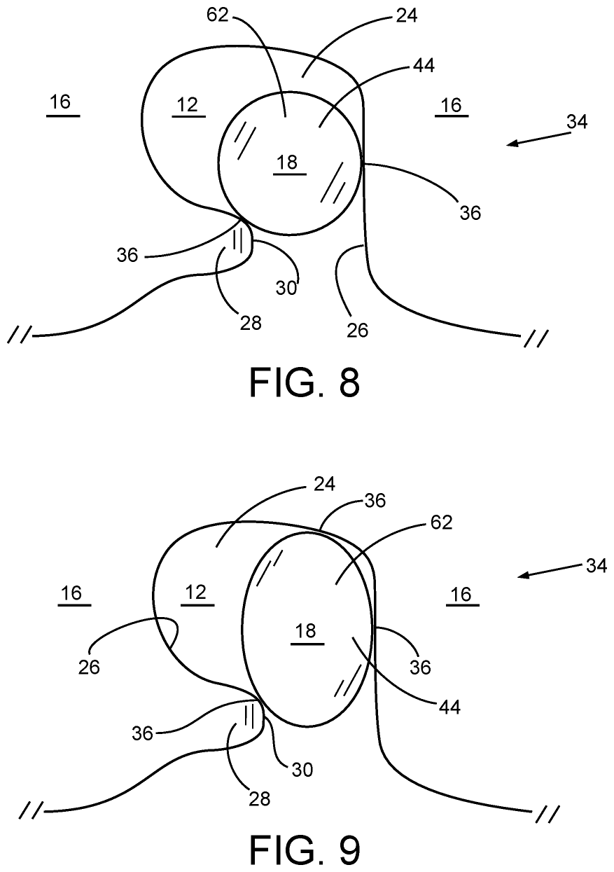

Referring to FIGS. 8 to 10, the attachment 18 may have any desired shape and size to produce the persistent repositioning force in any desired direction at any number of different contact points 36 along the cutout edge 26. In some embodiments, the aligner 16 in its fully installed position 34 extends partly over the gingiva of the patient.

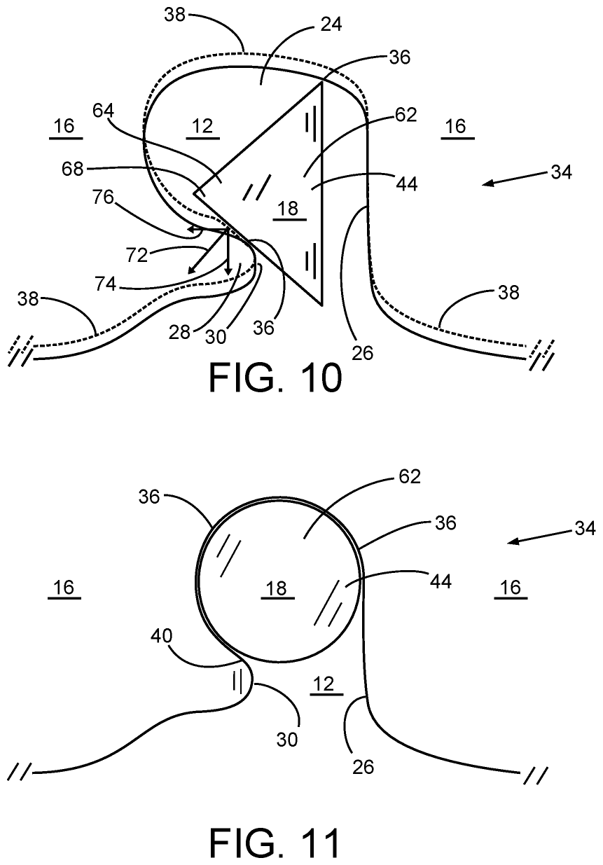

Referring to FIG. 10, the attachment body 44 has a protrusion 64 which projects in the opposite direction of the projection 28, and the attachment body protrusion 64 has a protrusion tip 68. During insertion of the aligner 16 the attachment body 44 deliver a compressive force on the projection 28. From a point of initial contact (FIG. 3), such compressive force increases as the aligner is moved toward its fully installed position 34 (FIG. 4). The projection 28 reaches the biggest deformation at the point of contact between the projection tip 30 and the protrusion tip 68, and at this point the attachment body 44 delivers maximum compressive force to the projection 28. Thereafter, the compressive force becomes reduced and released as the aligner 16 is moved into its fully installed position 34. Thus, the resilient engagement of the projection 28 against the attachment body 44 advantageously prevents incomplete installation of the aligner 16 by urging the aligner 16 toward its fully installed position 34 after having reached its midway point of maximum compressive force.

The minor displacement of the aligner 16 from its fully installed position 34 to a displaced position 38 causes compression of the resilient material of the projection 28, thereby urging the aligner 16 to return toward its fully installed position 34; the attachment body 44 delivers a compressive force 72 to the projection 28, and this compressive force 72 defines not only a horizontal component force 76, but also a vertical component force 74 that directs toward the gingiva and guides the aligner 16 to return to its fully installed position 34.

Referring to FIG. 11 in top view, the attachment body 44 has a shape and size that is harmonious (i.e. coincides) with the cutout 24, and the attachment body 44 has contact with most of the inner edge 40 at the fully installed position 34, and at this position 34 all the engagement force between the attachment body 44 and the aligner 16 is balanced, only displacement of the aligner 16 may trigger compressive force 72 (FIG. 10) which may urge the aligner 16 toward its fully installed position 34.

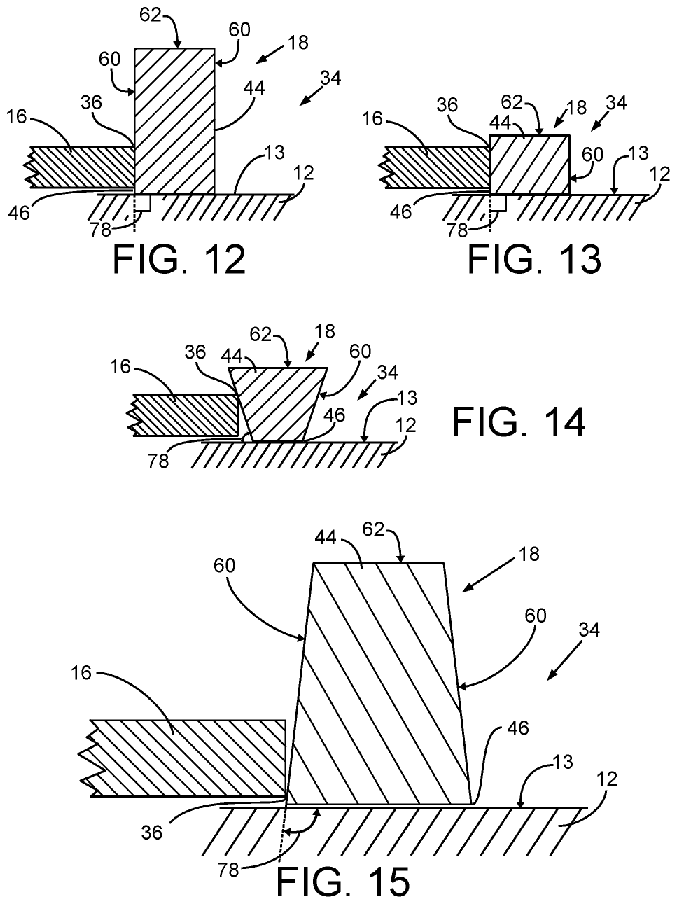

Referring to FIGS. 12 to 15 providing a side view along lines 12-12 of FIG. 6, these Figures only show the side view of a portion of the aligner 16 and the attachment 18 and for ease of illustration do not show the other parts of aligner 16. The attachment 18 includes its attachment body 44 projecting vertically away from its base 46 that is adjacent to the tooth surface 13. In the exemplary embodiments of FIGS. 12 and 13, the base 46 has the same width as the attachment body 44. In the exemplary embodiments of FIGS. 12 to 15, the aligner 16 in its fully installed position 34 contacts the attachment body 44 at the contact point 36.

Referring to FIGS. 12 and 13, the side surface 60 of attachment body 44 forms an angle 78 with the tooth surface 13 that is a right angle 78.

Referring to FIG. 13, the attachment body 44 in its direction of projection may have any suitable length. Typically, the attachment body 44 is at least as long as the thickness of the aligner 16 at the cutout edge so as to inhibit the projection 28 (FIG. 6 et al.) from sliding over the top surface 62 of the attachment body 44 and potentially displacing the aligner 16. Referring to FIGS. 6 and 12, the attachment body 44 in some embodiments is at least 1.4 times as long as the thickness of the aligner 16 at the cutout edge 26.

Referring to FIG. 14, the side surface 60 of the attachment body 44 forms the angle 78 with the tooth surface 13 which in this embodiment is an acute angle 78. In this embodiment the height of the attachment body 44 is longer than the thickness of the aligner 16. This embodiment inhibits the projection 28 from sliding over the top surface 62 of the attachment body 44.

Referring to FIG. 15, the side surface 60 of the attachment body 44 forms the angle 78 with the tooth surface 13 which in this embodiment is an obtuse angle 78. In this embodiment the length of the attachment body 44 is typically made sufficient to prevent the projection 28 (FIG. 6 et al.) sliding over the top surface 62 of the attachment body 44. The attachment body 44 in some embodiments is at least 1.4 or 1.8 times as long as the thickness of the aligner 16 at the cutout edge 26.

Referring to FIGS. 16 to 18, the base 46 in some embodiments extends from the attachment body adjacently to the given tooth surface 13 so as to advantageously define a larger surface area for attaching the attachment 18 to the given tooth 12. In variations, the base 46 can be attached to the attachment body 44 in any suitable manner, including being integrally attached as shown in FIGS. 16 to 18. In contrast to the embodiments of FIGS. 12 to 15, the exemplary embodiments of FIGS. 16 to 18 show the surface area of the base 46 being greater than the cross-sectional area of the attachment body 44.

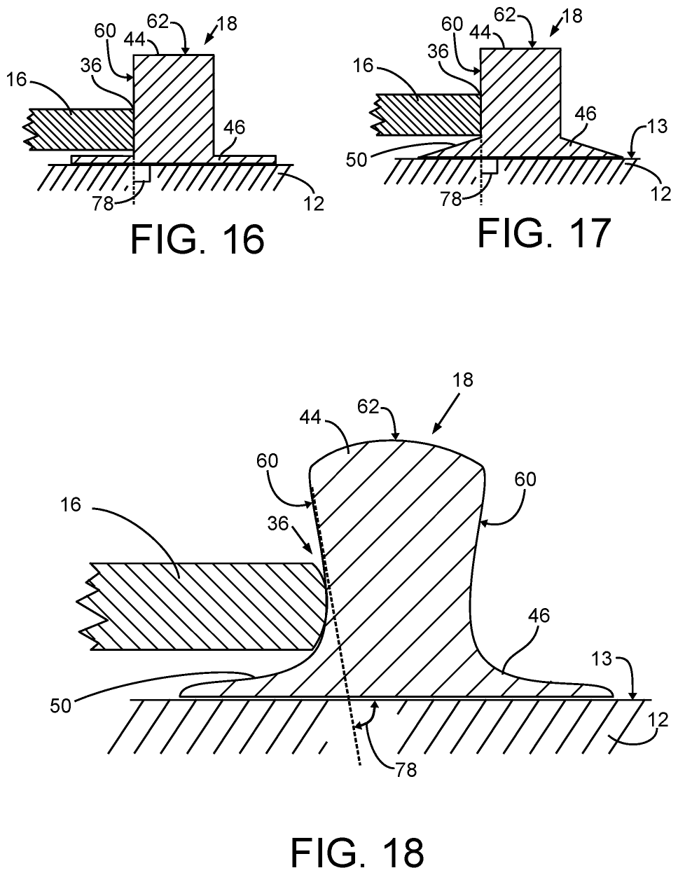

The base 46 may have any suitable shape, including circular, elliptical, polygonal, or irregular for example. The base 46 in some embodiments is beveled, such as by being sloped downwardly as viewed in FIG. 17 or having a smoothly rounded bevel 50 as shown in FIG. 18 for example.

The base 46 and the attachment body 44 in some embodiments have orthogonal surfaces, as shown in FIG. 16 for example. Additionally or alternatively, the base 46 and/or the attachment body 44 may have smoothly rounded edges, as shown in FIG. 18 for example. In the exemplary embodiment shown in FIG. 18, the attachment body 44 widens in the direction projecting away from the given tooth 12, thereby assisting in preventing the aligner 16 from sliding over top surface 62 of the attachment body 44.

Referring to FIG. 18, part of the side surface 60 of the attachment body 44 forms the angle 78 with the tooth surface 13 which in this embodiment is an acute angle 78. The attachment body 44 is longer than the thickness of the aligner 16 at the cutout edge, and such embodiment can prevent the aligner 16 from sliding over the top surface 62 of the attachment body 44.

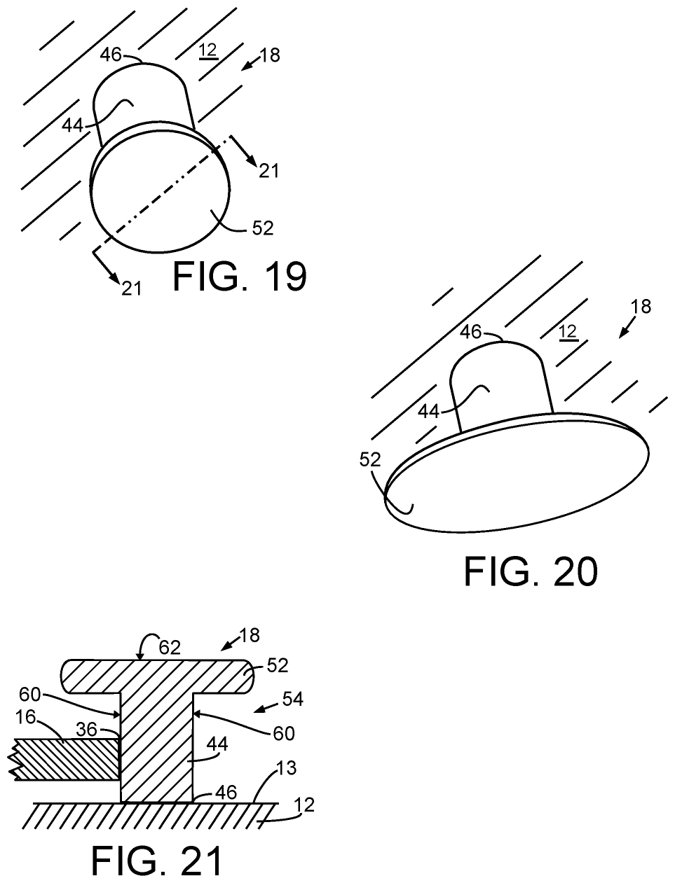

Referring to FIG. 19, the attachment 18 in some embodiments includes a wing 52 that extends radially away from the attachment body 44 distal from the base 46. The wing 52 typically extends wider than the attachment body 44. The wing 52 in some embodiments is elliptical as shown in FIG. 20. Other shapes of the wing 52 are possible, and in general the wing 52 may have any suitable shape. In some embodiments (not shown), the attachment 18 including any wing 52 is dimensioned to act as a hook for dental traction component(s) for example.

Referring to FIG. 21 providing a side view along lines 21-21 of FIG. 19, the attachment 18 defines a slot 54 between the wing 52 and the tooth surface 13. The wing 52 is dimensioned to constrain the aligner 16 and its cutout edge 26 between the tooth surface 13 and the wing 52, so as to prevent the projection 28 (FIG. 6 et al.) from sliding over top surface 62 of the attachment 18. The slot 54 width is equal to the distance between the wing 52 and the tooth surface 13 (or the base when the attachment has an enlarged base 46). The width of the slot 54 is bigger than the thickness of the portions of the cutout edge 26 that pass within the slot 54.

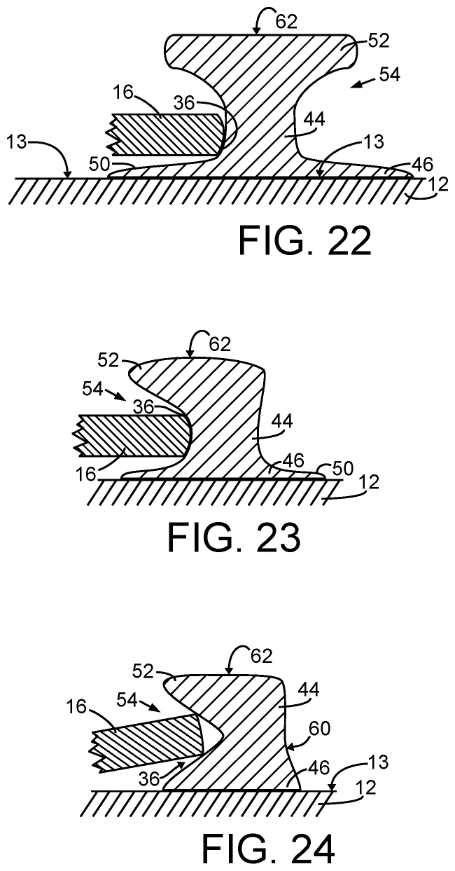

Referring to FIG. 22, the base 46 in some embodiments has a bevel 50 to provide a sloped guide of the aligner 16 into the slot 54. The slot 54 in general may have any suitable shape, including being smoothly rounded at its edges for example. In this embodiment the slot 54 width is equal to the distance between the wing 52 and the base 46, and the width of the slot 54 is bigger than the thickness of the portions of the cutout edge 26 that pass within the slot 54.

Referring to FIG. 23, the wing 52 typically extends beyond the width of the attachment body 44 at the contact point(s) 36 and does not necessarily (although it may) extend beyond the width of the attachment body 44 elsewhere. In some embodiments, the wing 52 and the slot 54 are one-sided as shown in FIG. 23.

Referring to FIG. 24, the slot 54 has an opening toward the aligner 16 and the opening is greater than the thickness of the aligner 16 at the cutout edge. In this embodiment, the opening of the slot 54 is greater than the thickness of the aligner 16 and some other parts of the slot 54 is not as great as the thickness of the aligner 16 at the cutout edge. Referring to FIGS. 21 to 24, the slot 54 at its opening has a width that is greater than the thickness of the aligner 16 at the cutout edge. This embodiment can keep the cutout edge of the aligner 16 sliding in the slot 54 without sliding over the top surface 62 of the attachment body 44.

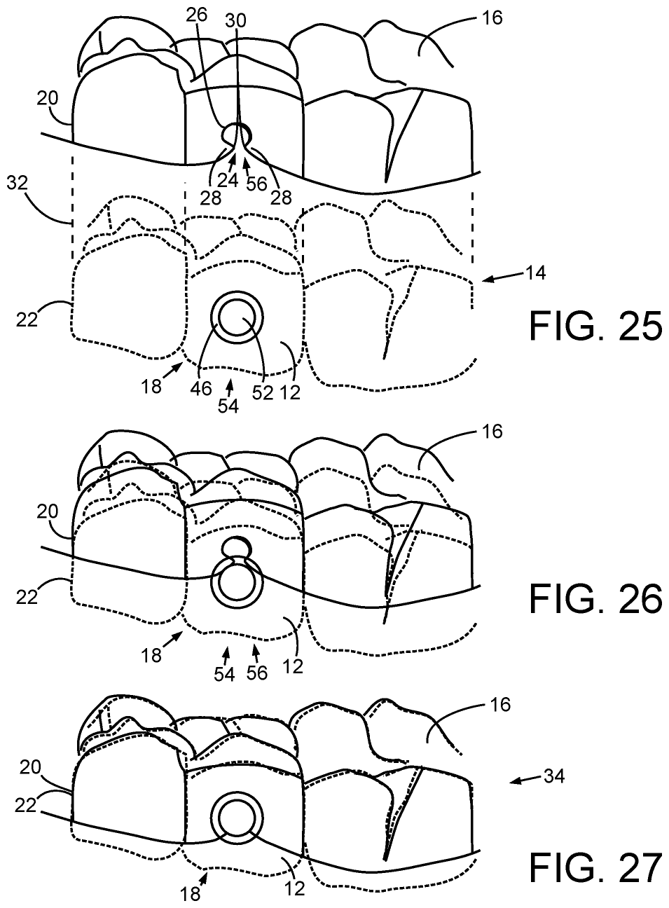

Referring to FIGS. 25 to 27, the cutout 24 of the aligner 16 in some embodiments defines more than one projection 28. In the exemplary embodiment of FIG. 25, the aligner 16 includes one cutout 24 whose cutout edge 26 defines a pair of opposing projections 28 that form a passage 56 between the opposing projections 28. As the aligner 16 is installed onto the dental arch 14, the attachment body 44 (not visible in FIGS. 25 to 27) passes through the passage 56 as the pair of projections 28 pass through the slot 54 defined by the base 46 and the wing 52. While in the exemplary embodiment of FIG. 25 the projections 28 forming the passage 56 are mirror images of each other, in general each projection 28 may have any suitable shape and size.

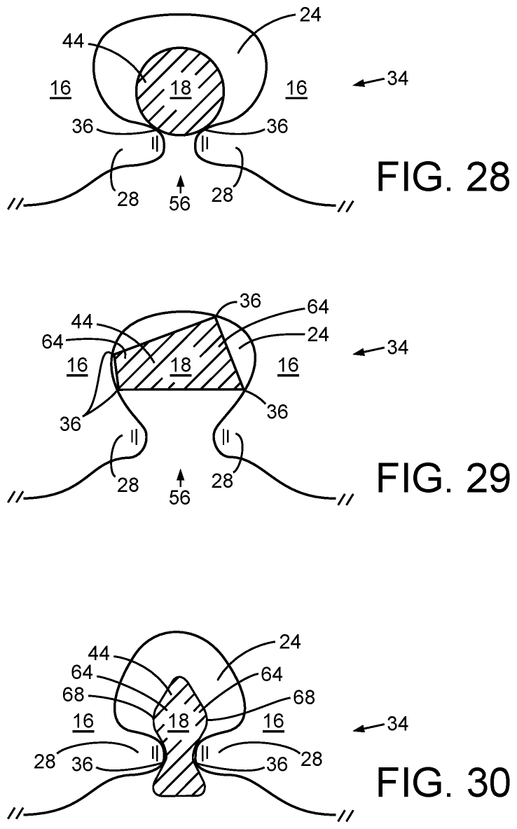

Referring to FIG. 28, the top view of the attachment body 44 (i.e. the attachment 18 with its base 46 and wing 52 removed for clarity) reveals a pair of contact points 36 between the attachment body 44 and each projection 28 when the aligner is in its fully installed position 34.

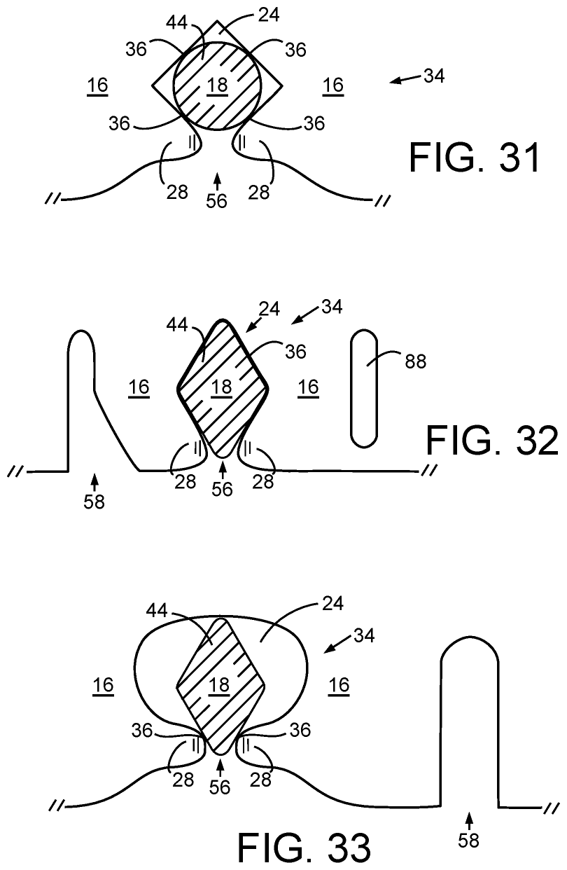

Referring to FIGS. 29 to 31, the attachment body 44 has a cross-sectional shape that may be any suitable shape, and the cutout 24 may have any suitable shape. Examples of various shapes for the attachment body 44 and cutout 24 are shown in FIGS. 29 to 31, including the diamond-shaped cutout 24 of FIG. 31. Referring to FIG. 30, part of the attachment body 44 may extend out of the cutout 24. In this situation the projection 28 is at the lingual side of part of the attachment body 44, and the projection 28 is at the lingual side of the attachment body protrusion 64.

Referring to FIG. 32, the attachment body 44 in some embodiments has a cross-sectional shape that is diamond-shaped. The diamond-shaped cutout 24 that conforms to the diamond-shaped attachment body 44 advantageously provides a strong retention force.

Referring to FIGS. 32 and 33, the aligner 16 in some embodiments includes one or more secondary cutout(s) 58 or window(s) 88 that are dimensioned to not engage with any attachment 18 when the aligner 16 is in its fully installed position 34. The secondary cutout(s) 58 increase the flexibility of the aligner 16 material, thereby decreasing the retention force required to move the projection 28 past the attachment 18, and thus makes intentional installation and removal of the aligner 16 easier while advantageously causing no minor displacement of the aligner 16.

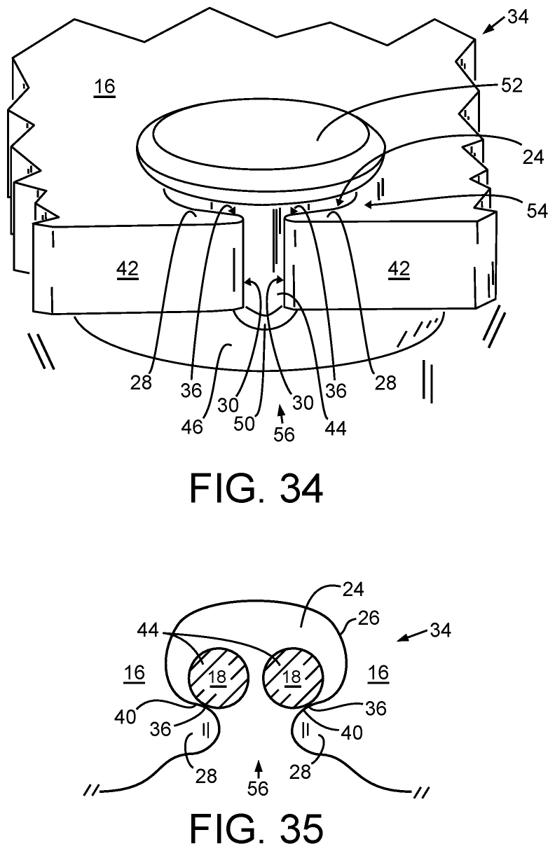

Referring to FIGS. 33 and 34, the attachment 18 in a particular exemplary embodiment has a circular, beveled base 46; a circular wing 52 having radius less than that of the base 46; and an attachment body 44 having a diamond-shaped cross-section (best seen in FIG. 33). The aligner 16 in the particular exemplary embodiment has a cutout 24 with a bulbous shape that defines a pair of opposing projections 28 that are mirror images of each other and define a symmetrical passage 56 in the middle, and includes one secondary cutout 58 (FIG. 33). The attachment 18 and aligner 16 together define three contact points 36 (only two of which are visible in FIG. 34). In an exemplary variation, the secondary cutout 58 of FIG. 33 may be disposed distal (i.e. rearward in the mouth) or mesial (i.e. forward in the mouth) of the cutout 24.

Referring to FIG. 35, in some embodiments a pair of attachments 18 engage with a pair of projections 28 when the aligner 16 is being installed, respectively. In variations, each attachment 18 may include neither, one, or both of an extended-width base 46 (not shown in FIG. 35) and a wing 52 (not shown in FIG. 35). When the aligner 16 is in its fully installed position 34 of FIG. 35, each attachment 18 contacts the cutout edge 26 at one contact point 36. The contact points 36 in the exemplary embodiment of FIG. 35 are located along the inner edge 40 of the projections 28, respectively. In general, however, any number of attachments 18 and any number of contact points 36 may be employed in association with any given cutout 24 of the aligner 16.

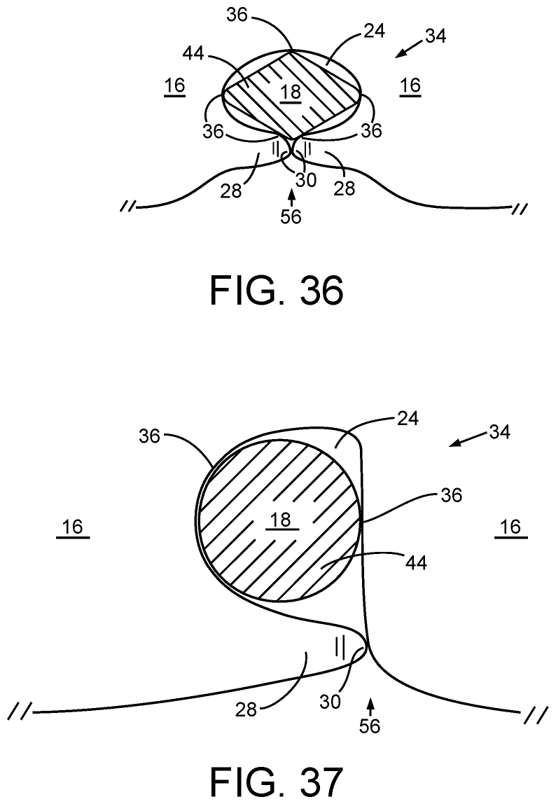

Referring to FIG. 36, in some embodiments the projection tip 30 extends to contact the other projection tip 30 at the opposite side of the passage 56, and the passage 56 is opened by the attachment body 44 during the insertion and removal of the aligner 16. The passage 56 is opened as the attachment body 44 passes through the passage 56 and separates the contact between the opposing projection tips 30 by squeezing the respective projections 28. After insertion or removal of the aligner 16, the respective projections 28 relax to re-close the passage 56 and resume contact between the respective projection tips 30 at the passage 56.

Referring to FIG. 37, in some embodiments the projection tip 30 extends to contact a different portion of the aligner 16 at the other side of the passage 56, and the passage 56 is opened by the attachment body 44 during the insertion and removal of the aligner 16. The passage 56 is opened as the attachment body 44 passes through the passage 56 and compresses the projection 28 so as to separate the contact between the projection tip 30 and the other portion of the aligner 16. After insertion or removal of the aligner 16, the projection 28 relaxes to re-close the passage 56 and resume contact between the projection tip 30 and the other portion of the aligner 16.

### REFERENCE CHARACTER LIST

Orthodontic appliance 10

Teeth 12

Tooth surface 13

Dental arch 14

Aligner 16

Attachment 18

Ridge 20

Indentation 22

Cutout 24

Cutout edge 26

Projection 28

Projection tip 30

Insertion route 32

Fully installed position 34

Contact point 36

Displaced position 38

Inner edge 40

Attachment body 44

Base 46

Bevel 50

Wing 52

Slot 54

Passage 56

Secondary cutout 58

Side surface of attachment body 60

Top surface of attachment body 62

Attachment body protrusion 64

Attachment body protrusion tip 68

Compressive force 72

Vertical component force 74

Horizontal component force 76

Angle 78

Window 88

While embodiments of the invention have been described and illustrated, such embodiments should be considered illustrative of the invention only. The invention may include variants not described or illustrated herein in detail. Thus, the embodiments described and illustrated herein should not be considered to limit the invention as construed in accordance with the accompanying claims.

1. An orthodontic appliance for repositioning teeth, the appliance comprising:
(a) an aligner having a thickness and having one or more cutouts for being located coincident with the buccal and/or lingual surface of the teeth when the aligner is installed, and the cutout having an opening dimensioned for being oriented towards the gingival, wherein a projection of the aligner from the mesial side and/or the distal side of the cutout toward the interior of the cutout is provided; and
(b) one or more attachments is dimensioned for being attached to the tooth surface whereat the cutout is aligned, the attachment having a body and a base, the base being connected to the tooth surface, the body projecting away from the tooth, wherein the height of the body is longer than the thickness of the aligner at the cutout edge,
wherein a tip of the projection is at the gingival side of at least part of the attachment body when the aligner is in its fully installed position and the projection contacts the attachment body, the side surface of the attachment body being dimensioned to inhibit the projection from sliding over the top surface of the attachment body when the aligner is being displaced from its fully installed position.

2. The orthodontic appliance of claim 1 wherein the attachment comprises a wing separated from the base, a slot being formed between the wing and one of the base and the tooth surface, the slot being formed between the wing and the tooth surface when the base does not extend laterally beyond the attachment body, the slot having an opening whose width is bigger than the thickness of the aligner at the cutout edge.

3. The orthodontic appliance of claim 1 wherein at least part of the side surface of the attachment body forms one of an acute and a right angle with the tooth surface.

4. The orthodontic appliance of claim 1 wherein at least part of the side surface of the attachment body forms an angle with the tooth surface that is smaller than 130 degrees.

5. The orthodontic appliance of claim 2 wherein the attachment base is contoured for an intimate fit with the local tooth surface, the base having a beveled edge such that the aligner is slidable over the base, the base being covered by the aligner when the aligner is in its fully installed position.

6. The orthodontic appliance of claim 2 wherein the projection tip is smoothly rounded.

7. The orthodontic appliance of claim 2 wherein the aligner has a secondary cutout dimensioned to not engage with any said attachment.

8. The orthodontic appliance of claim 2 wherein the attachment body contacts only a portion of the cutout edge when the aligner is inserted into the fully installed position.

9. The orthodontic appliance of claim 2 wherein the aligner is dimensioned to extend to cover a portion of gingiva around the teeth when the aligner is in the fully installed position.

10. The orthodontic appliance of claim 1 wherein the attachment is dimensioned for use with each of a plurality of different said aligners.

11. The orthodontic appliance of claim 1 wherein the tip of the projection is dimensioned to contact a portion of the aligner at an opposite side of the cutout, the attachment body being operable to separate contact between the tip of the projection and the portion during insertion and removal of the aligner.

12. The orthodontic appliance of claim 1 wherein the height of the attachment body is at least 1.4 times the thickness of the aligner at the cutout edge.

13. The orthodontic appliance of claim 4 wherein the height of the attachment body is at least 1.8 times the thickness of the aligner at the cutout edge.

14. An orthodontic appliance for repositioning a tooth of a dental patient, the appliance comprising:
(a) an attachment dimensioned for being attached to the tooth; and
(b) an aligner having a thickness and having a cutout therein defining a cutout edge, the cutout edge defining a projection, the cutout having an opening dimensioned for being oriented toward gingival, wherein the projection and the attachment are dimensioned to resiliently engage with each other to hinder displacement of the aligner from its fully installed position.

15. The orthodontic appliance of claim 14 wherein the attachment has a body and a base, the base connected to the tooth surface, the body projecting away from the tooth, the projection tip being positioned at the lingual side of at least part of the body and contacting the attachment body when the aligner is fully installed.

16. The orthodontic appliance of claim 15 wherein the side surface of the attachment body is dimensioned to inhibit the projection from sliding over the top surface of the attachment when the aligner is being displaced from its fully installed position.

17. The orthodontic appliance of claim 16 wherein the height of the attachment body is greater than the thickness of the aligner at the cutout edge.

18. The orthodontic appliance of claim 17 wherein at least part of the side surface of the attachment body forms one of an acute and a right angle with the tooth surface.

19. The orthodontic appliance of claim 17 wherein at least part of the side surface of the attachment body forms an angle with the tooth surface that is smaller than 130 degrees.

20. The orthodontic appliance of claim 17 wherein the attachment comprises a wing separated from the base, a slot being formed between the wing and one of the base and the tooth surface, the slot being formed between the wing and the tooth surface when the base does not extend laterally beyond the attachment body, the slot having an opening whose width is bigger than the thickness of the aligner at the cutout edge.

21. The orthodontic appliance of claim 19 wherein the height of the attachment body is at least 1.4 times the thickness of the aligner at the cutout edge.
